(19) United States
(12) Patent Application Publication
(10) Pub. No.: US 2023/0286201 A1
(43) Pub. Date: Sep. 14, 2023

(54) METHOD AND APPARATUS FOR THE PRODUCTION OF PLASTIC CONTAINERS WITH NONCIRCULAR CROSS SECTION

(71) Applicant: KRONES AG, Neutraubling (DE)

(72) Inventor: Sebastian STEGER, Regensburg (DE)

(21) Appl. No.: 18/119,158

(22) Filed: Mar. 8, 2023

(30) Foreign Application Priority Data
Mar. 8, 2022 (DE) 10 2022 105 331.8

(51) Int. Cl. B29C 49/42; B29C 49/64; B29C 49/78

(52) U.S. Cl. CPC B29C 49/42119; B29C 49/42065; B29C 49/6418; B29C 49/78; B29C 2049/7878

(57) ABSTRACT

Plastic preforms are transported during their heating along a predetermined transport path and rotated with respect to their longitudinal axis during transport along a first transport path section to achieve uniform heating of the plastic preforms in the circumferential direction. The plastic preforms remain at least in sections in a predetermined first rotational position with respect to their longitudinal axis during their transport along a second transport path section so that first predetermined circumferential sections of the plastic preforms are heated differently from second predetermined circumferential portions of the plastic preforms. The plastic preforms remain at least in sections in a predetermined second rotational position with respect to their longitudinal axis during their transport along the second transport path section, the first and the second rotational position differing from one another by a predetermined differential angle.

### BACKGROUND OF THE INVENTION

The present invention relates to a method and apparatus for manufacturing plastic containers. Such processes have been known in the prior art for a long time. Usually, a plastic preform is first heated and then formed into a plastic container in a forming device, such as a stretch blow-moulding machine. On the market, containers are sometimes also desired which have a cross-section deviating from a circular cross-section, such as an oval cross-section. For this purpose, it is possible to use oval blow moulds which form an oval container accordingly.

However, in such cases, the heating process must also be adapted. For the production of unevenly shaped and in particular oval containers, the so-called preferential heating process is used in the state of the art. In this process, the two sides of the plastic preform that are to be formed into the long sides of the container are heated more than the two sides of the plastic preform that are to be formed into the short sides of the container.

For this purpose, it is known that in the course of the heating process, the plastic preforms are first provided with a uniform basic heating and then certain areas of the plastic preform are heated more strongly. For example, preferential heating with comparable heat input on two opposite sides each is known. These two opposite, then warmer sides of the plastic preform lead to two equally stretched longer container sides. The two opposite shorter sides lead to two equally stretched shorter container sides.

In addition, it is also possible in principle to provide a so-called preferential heating with different heat input on two opposite sides to the other two sides with comparable heat input. In this way, oval but not symmetrical containers can be created. In this case, for example, two opposite sides on the plastic preform can be subjected to a maximum and a medium temperature and thus lead to two unequally stretched long container sides. Two opposite sides of the plastic preform, on the other hand, can be subjected to a lower temperature and thus lead to two equally stretched short container sides.

In this way, oval containers or also oval containers with an asymmetrical course on the long side of the container can be produced.

In a correspondingly known process, the plastic preforms are first guided through a heating lane in which they are irradiated on one side and rotated at the same time in order to achieve the required basic thermal level. Then the rotation is stopped and the plastic preforms are led through a heating lane with irradiation on both sides. Should it be necessary that the sides of the plastic preforms heated in this course do not have the same temperature, this can be easily implemented via a radiator power control technique.

In some cases, however, it would also be desirable to produce non-uniformly shaped and, in particular, oval containers that have an asymmetrically shaped short container side.

### SUMMARY OF THE INVENTION

In a method for manufacturing plastic containers according to the invention, plastic preforms are heated by means of a heating device and then these heated plastic preforms are formed into the plastic containers. In this process, these plastic preforms are transported along a predetermined transport path during their heating, and the plastic preforms are rotated with respect to their longitudinal axis along a first transport path section during transport, in order to achieve uniform (basic) heating of the plastic preforms (in particular in their circumferential direction) in this way.

Furthermore, during their transport along a second transport path section, the plastic preforms are at least in sections substantially maintained and/or held in a predetermined first rotational position with respect to their longitudinal axis, so that first predetermined circumferential sections of the plastic preforms are heated differently (i.e. in particular more or less strongly) than second predetermined circumferential sections of the plastic preforms.

According to the invention, during their transport along the second transport path section, the plastic preforms remain and/or are held at least in sections essentially in a predetermined second rotational position with respect to their longitudinal axis, wherein the first and second rotational positions differing from one another by a predetermined differential angle.

Holding the plastic preforms in a certain rotational position is understood to mean that they are transported further along their transport path but are not rotated about their longitudinal axes during this transport. Remaining essentially in this rotational position is understood to mean that the plastic preforms remain precisely in this rotational position. However, it would also be conceivable that the plastic preforms are rotated very slowly, for example only by a few degrees along this section of the heating.

It is thus proposed that the plastic preforms are held in at least two different rotational positions and preferably also heated in these rotational positions. Particularly preferably, the plastic preforms are heated during their transport from at least one and preferably at least two preferred directions. These preferred directions are in particular directions perpendicular to the transport path of the plastic preforms. In this way, some sections of the circumferential wall of the plastic preforms are heated more than other sections.

In this way, opposite circumferential sections are heated differently as a result and in this way, different long sides of a cross-sectional profile of the plastic containers are produced.

Preferably, the plastic preforms are transported through a transfer section between the first transport path section and the second transport path section. Preferably, a direction of movement of the plastic preforms is deflected in this transfer section and in particular deflected by 180°. Particularly preferably, no heating of the plastic preforms takes place in this transition section.

Preferably, the plastic preforms are transported past stationary heating units, which emit infrared radiation to heat the plastic preforms. For this purpose, these heating units can have emitters, in particular infrared emitters, which emit radiation that heats the plastic preforms, as is known from the prior art.

Particularly preferably, the first transport path section and/or the second transport path section run essentially and in particular completely in a straight line. Particularly preferably, the plastic preforms are transported by means of a circulating transport device. Particularly preferably, the plastic preforms are transported individually. Preferably, the plastic preforms are held by holding devices. These holding devices can in particular be holding mandrels which can be inserted into the mouths of the plastic preforms. Particularly preferably, these holding devices, i.e. here the holding mandrels, are also rotated together at least in sections with the plastic preforms held by them with respect to a longitudinal direction of the plastic preforms.

Preferably, the plastic preforms are heated by the application of radiation and in particular infrared radiation.

In a further preferred embodiment, the differential angle is greater than 20°, preferably greater than 40°, preferably greater than 60°, preferably greater than 70° and particularly preferably greater than 80°. In a further preferred embodiment, the differential angle is smaller than 160°, preferably smaller than 140°, preferably smaller than 120°, preferably smaller than 110° and particularly preferably smaller than 100°.

Particularly preferably, the differential angle is essentially and especially exactly 90°. In this way, the special symmetries mentioned above can be achieved. However, the other reference angles could also be interesting in order to respond individually to customer wishes with regard to the cross-sectional profile of the containers.

Preferably, the plastic preforms are first held in the first rotational position (but continue to be transported along the transport path), then rotated through a predetermined angle and then held in the second rotational position (but continue to be transported along the transport path).

Particularly preferably, the second transport path section adjoins the first transport path section.

Particularly preferably, the plastic preforms are rotated from the first rotational position to the second rotational position by means of a mechanically acting setting device. Particularly preferably, the plastic preforms are also rotated into the first rotational position by means of a mechanical setting device.

In a further preferred method, the plastic preforms are held by the mechanical setting device in the first rotational position and are also transported in this first rotational position. In a further preferred method, the plastic preforms are held by the mechanical setting device in the second rotational position and are also transported in this second rotational position.

Particularly preferably, during the transport of the plastic preforms in the second transport path section, opposite circumferential sections are heated differently, at least in sections. This can be achieved, for example, by a different heating power of heating units, which are located in particular laterally next to the transport path of the plastic preforms.

Preferably, the plastic preforms are transported through a heating lane in this area and heating units are arranged on both sides of this heating lane, in particular in a stationary manner. In this way, different heating can be achieved by varying the radiant power of the heating units.

In a further preferred method, the forming device forms plastic containers with a cross-section deviating from a circular cross-section from the plastic preforms. In particular, these are plastic containers with an oval cross-section, wherein the opposing short sections of this cross-section are particularly preferably not symmetrical with respect to the longitudinal axis of the containers. Particularly preferably, the longitudinal axis of the container runs symmetrically with respect to a mouth of the container.

In a further preferred method, the plastic preforms are cooled at least in sections during their transport and/or during their heating along the transport path on their outer surface. In particular, cooling is carried out by air. In this way, uniform heating of the peripheral wall of the plastic preforms is achieved. This procedure has proven to be particularly advantageous for the non-circular containers described here, since different wall sections of the manufactured plastic containers may have different wall thicknesses.

In a further preferred embodiment, a detection device detects a rotational position of the plastic preforms with respect to their longitudinal direction. In some applications, it can be useful to precisely align the plastic preforms or their threads, since the manufactured plastic containers also have to be adapted to certain container closures, in particular oval ones. Particularly preferably, the detection device detects the rotational position of the plastic preforms by means of a marking on the plastic preforms. In this way, for example, a rotational position of the plastic preform can already be aligned before the heating process or in particular before the so-called preferential heating takes place. Particularly preferably, the plastic preform can be aligned with respect to its holding device, or the plastic preform, which is arranged on the holding device such as a holding mandrel, can be aligned.

The present invention is further directed to an apparatus for manufacturing plastic containers. The apparatus comprising a heating device which heats plastic preforms, wherein the heating device comprises a transport device which transports the plastic preforms along a predetermined transport path during their heating, and wherein the heating device comprises at least one and preferably a plurality of heating units which heat the plastic preforms by applying electromagnetic radiation, and wherein the heating device comprises a rotating device which rotates the plastic preforms during their transport along a first transport path section with respect to their longitudinal axis, in order to achieve in this way a uniform heating of the plastic preforms.

Furthermore, the heating device has a setting device which has the effect that the plastic preforms, during their transport along a second transport path section, are transported at least in sections in a predetermined first and, in particular, fixed rotational position with respect to their longitudinal axis, so that first predetermined circumferential sections of the plastic preforms are heated differently than second predetermined circumferential sections of the plastic preforms.

According to the invention, the setting device causes the plastic preforms to be transported at least in sections in a predetermined second (in particular fixed) rotational position with respect to their longitudinal axis during their transport along the second transport path section, wherein the first and second rotational positions differing from one another by a predetermined differential angle.

It is thus also proposed with regard to the apparatus that the plastic preforms are transported section by section in at least two different (and in particular fixed) rotational positions and in this way are heated more strongly at preferred surface areas than at others.

Particularly preferably, the rotating device is a mechanically acting rotating device. Particularly preferably, this rotating device causes a uniform rotation of all plastic preforms at least during transport in the first transport path section. This rotating device can, for example, have a toothed rack opposite which the plastic preforms or gearwheels (which are coupled to the holding devices of the plastic preforms) roll or with which they engage.

Particularly preferably, the heating units are infrared heating units.

Particularly preferably, the transport device has a plurality of holding devices. These are particularly preferably rotatably mounted and particularly preferably have a guide roller. This guide roller can cooperate with a guide cam, as described in more detail below, in order to hold the plastic preforms in a specific rotational position.

Particularly preferably, the setting device has at least one guide cam arranged stationary (in particular in the transport direction and/or at least in a working mode of the apparatus), which enables the plastic preforms to be transported in a predetermined rotational position.

As mentioned, this guide cam preferably interacts with a cam roller which is coupled to the holding devices.

The guide curve as a whole (i.e. both the first and the second section) is preferably displaceable for controlling or regulating the transfer angle. It could also be useful that the second section is displaceable relative to the first section and at the same time both sections are displaceable together relative to the machine frame or that all curve sections are independently individually displaceable relative to the machine frame.

Preferably, the setting device has at least one guide curve which is not moved with the transport device (for transporting the plastic preforms).

In a preferred embodiment, the guide curve has at least three successive curve sections, wherein preferably one of these curve sections being a catch curve section which aligns a rotational position of the plastic preforms, at least one curve section being a first holding curve section which holds the plastic preforms in the first rotational position during their transport, and at least one curve section being a second holding curve section which holds the plastic preforms in the second rotational position during their transport. Thus, it is proposed here that the adjustment of the rotational position of the plastic preforms is performed mechanically using guide curves.

It should be noted that it would also be conceivable to design each individual holding device with its own, for example, electric drive, so that the rotational position of the plastic preforms could be adjusted in this way. However, since such ovens have a plurality of holding devices, this approach would be associated with relatively high costs.

In a preferred embodiment, the guide curve has a transfer section that rotates the plastic preforms from the first rotational position to the second rotational position. For example, the plastic preforms can be rotated through a defined angle, such as 90°, by means of a guide curve or the transfer section. In a preferred embodiment, the guide curve has a further transfer section which rotates the plastic preforms (10) from the second rotational position into a further and, in particular, into the first rotational position again.

In a preferred embodiment, at least one guide cam section is adjustable in a direction which is perpendicular to the transport path of the plastic preforms and which is also preferably perpendicular to the longitudinal direction of the plastic preforms. In this way, the rotational positions to be set can be adjusted and/or changed.

Heating units are particularly preferably arranged at least in sections in the second transport path section at least on one side and preferably on both sides of the transport path of the plastic preforms. These heating units are particularly preferably controllable independently of each other. In this way, the plastic preforms can be heated differently from the two different sides.

In a further preferred embodiment, the apparatus comprises at least one inspection device which is suitable and intended for detecting a rotational position of the plastic preforms with respect to their longitudinal direction. Particularly preferably, this is an optical inspection device which has, for example, an image recording device which records an image of the plastic preform. Particularly preferably, the rotational position of the plastic preform can be detected by means of a marking arranged thereon. Particularly preferably, this inspection device detects the rotational position of the plastic preforms without contact.

In a further advantageous embodiment, the apparatus comprises a forming device which forms the plastic preforms heated by the heating device into plastic containers, wherein this forming device preferably being suitable and intended for producing plastic preforms having a cross-section deviating from a circular cross-section. Preferably, this forming device is a blow moulding machine and in particular a stretch blow moulding machine.

In particular, this cross-section is an oval cross-section of the plastic preforms and in particular also a profile that is both oval and asymmetrical with respect to at least two sides of the containers. This will be explained in more detail with reference to the figures.

### BRIEF DESCRIPTION OF THE DRAWINGS

Further advantages and embodiments can be seen in the attached drawings.

In the drawings:

FIG. 1 shows a schematic representation of an apparatus according to the invention;

FIG. 2 shows a representation of a holding device for holding the plastic preforms;

FIG. 3 shows a top view of the holding device from FIG. 2;

FIG. 4 shows a detailed representation of the heating device;

FIG. 5 shows a representation of the setting device for changing the rotational position of the plastic preforms;

FIG. 6 shows an illustration for changing the rotational position of the plastic preforms;

FIG. 7 shows a further illustration of a holding device for holding the plastic preforms;

FIG. 8 shows a top view of the holding device from FIG. 7;

FIG. 9a,b show an illustration for the production of a container;

FIG. 10a,b show an illustration for the production of a plastic container with an asymmetrical cross-section;

FIG. 11 shows a schematic representation of an apparatus for producing a plastic container with an asymmetrical cross-section;

FIG. 12a,b show an illustration of the production of a plastic container with an asymmetrical cross-section on the short sides;

FIG. 13 shows a representation illustrating the plastic container shown in FIG. 12b; and

FIG. 14 shows a guide cam arrangement for producing the plastic container shown in FIG. 12b.

### DETAILED DESCRIPTION OF THE INVENTION

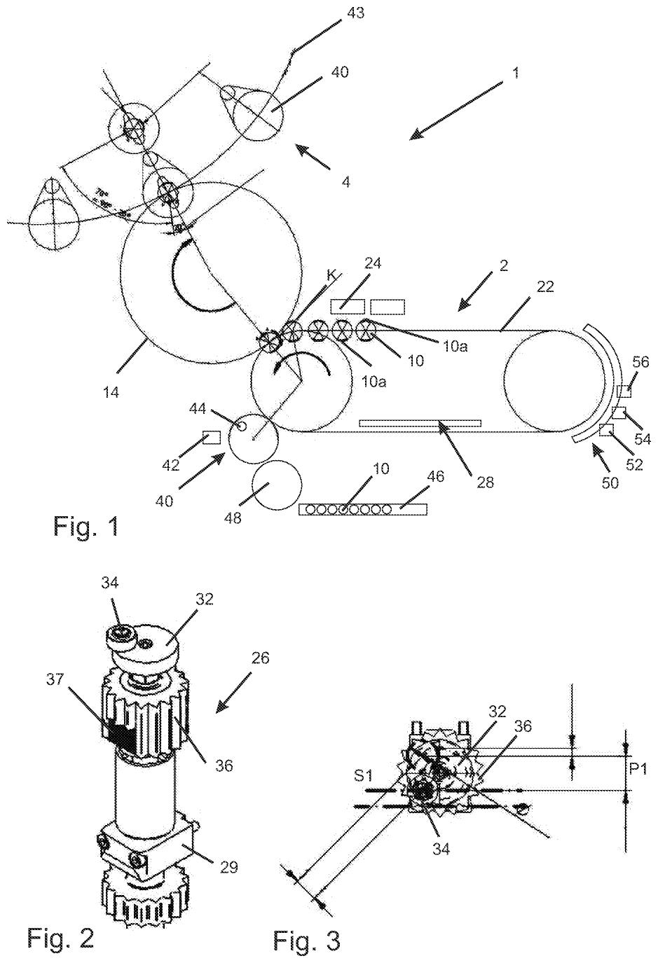

FIGS. 1-8 show an apparatus for manufacturing containers according to the internal prior art and serve to illustrate the invention. However, it is noted that all features of the apparatus shown in FIGS. 1-8 can also be used with the invention.

FIG. 1 shows a schematic representation of an apparatus 1 for manufacturing containers. The reference sign 2 refers to a heating device such as an oven which heats plastic preforms 10. Preferably, this is an infrared heating device. This heating device has a transport device 22, shown only schematically, which is designed here as a circulating chain on which a plurality of holding devices (not shown) are arranged for holding the plastic preforms 10.

The reference sign 24 indicates a heating unit such as a heating box, which is preferably stationary and past which the plastic preforms are transported. In a preferred embodiment, heating units are also provided on the inside of the transport path.

In a preferred embodiment, the heating device also has cooling devices which are suitable for cooling a surface of the plastic preforms, for example by applying air. In this way, uniform heating of the plastic preforms along their wall can be achieved.

As mentioned at the beginning, the plastic preforms are to be heated at preferred areas 10a, here at the areas shown in FIG. 1. For this purpose, the plastic preforms are aligned in their rotation so that some sections 10a are heated more than others.

The plastic preforms heated in this way are transferred by means of a transport device 14, such as a transport star, to the forming device designated in its entirety as 4. This has a plurality of forming stations 40, which are arranged on a transport device 43 such as a blowing wheel. The plastic preforms are fed into these forming stations or blow moulds and formed into containers.

Several transport devices such as transport stars, for example at least two and preferably at least three transport devices, can also be arranged between the heating device and the forming device.

In the area marked K, a correction of the rotational position of the plastic preforms can be made. In the forming device 4, the more heated surfaces of the plastic preforms are aligned with the respective longer sides of the blow moulds. Preferably, the plastic preforms are aligned in such a way that a parting side or parting plane is arranged on the narrow side of the container. The reference sign 28 roughly schematically indicates a drive device or rotating device for rotating the plastic preforms 10 with respect to their longitudinal directions. This drive device can, for example, be designed as a toothed rack which meshes with gearwheels (not shown) which are assigned to the individual holding devices of the plastic preforms.

Preferably, the holding devices are each equipped with a coupling device (not shown), which can cancel a coupling of the rotational movement of the gearwheel and the individual holding elements such as holding mandrels, so that at least in sections the holding devices 26a (cf. FIG. 7) are freely rotatable.

The reference sign 40 indicates an alignment device which serves to align the rotational position of the plastic preforms with respect to the holding devices holding them. This alignment device 40 preferably has an inspection device 42 which detects a rotational position of the plastic preforms 10. In addition, a turning device is provided which changes the rotational position of the plastic preforms, in particular turns the plastic preforms into a desired rotational position.

The reference sign 46 indicates a preform feed device such as a feed rail, which feeds the plastic preforms 10 one after the other to the alignment device 40. The reference sign 48 indicates a separating device which separates the plastic preforms 10 fed in a row. This separating device can be a saw-tooth starwheel.

The reference sign 50 indicates an optional rotational position alignment device, which can be provided instead of or in addition to the alignment device. This rotational position alignment device is preferably arranged in a deflection area of the heating device 2. The reference sign 52 indicates an inspection device which detects a rotational position of the plastic preforms 10 (held by the holding devices such as, in particular, holding mandrels).

The reference sign 54 indicates a decoupling device which at least briefly removes a coupling between the drive device 28 and the holding devices so that the plastic preforms are free with respect to their longitudinal directions. The reference sign 56 indicates a rotational position adjustment device which adjusts a rotational position of the plastic preforms to a desired position.

However, it would also be possible that the drive device, such as a toothed rack, is not present in the area of the deflection and for this reason the holding devices with the plastic preforms arranged on them can rotate freely.

FIG. 2 shows a representation of a holding device 26, which has a carrier 29 that can be arranged on a circulating transport means such as a transport chain. The reference sign 32 indicates a rotatable plate on which a cam follower 34 is arranged. This plate is rotatable with respect to the longitudinal direction L. This longitudinal direction also corresponds to the longitudinal direction of the plastic preform (not shown).

The reference sign 36 indicates a gear wheel or a gear rim which can roll with respect to or engage with a (not shown) stationary toothed rack. A coupling device (not shown) can be arranged between this gear rim and the (not shown) holding mandrel, which can decouple the rotary movement of the gear rim from the rotary movement of the plastic preform.

The reference sign 37 indicates an alignment surface which serves to pre-direct the rotational position of the plastic preform. In this way, a defined rotational position of the plastic preform can be achieved.

FIG. 3 shows a top view of the holding device shown in FIG. 2. Here again the cam follower 34 is provided, which is arranged on the rotatable plate 32. The gear wheel 36 can also be seen.

The reference sign P1 indicates a travel path of a corresponding guide curve when an angular correction, for example by 90°, is to be made. The reference sign S1 indicates a curve position for directional heating or preferential heating of certain areas of the plastic preform.

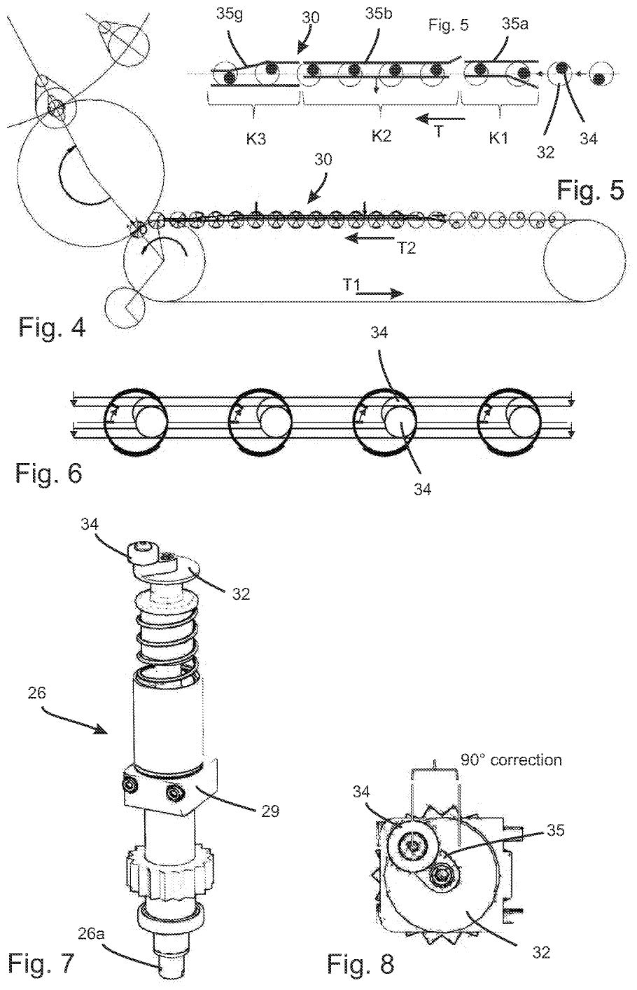

FIG. 4 shows a detailed representation of the apparatus shown in FIG. 1. The reference sign 30 indicates a setting device which serves to align the plastic preforms or their rotational position. Preferably, this setting device is arranged in the second half of the transport path along which the plastic preforms are transported during their heating.

FIG. 5 shows a detailed representation of this setting device. Here, it has cam segments 35a, 35b and 35c arranged one behind the other along the transport path T. The reference sign 35a indicates a catching cam which is suitable and intended for catching the cam follower 34 or gripping it in any position. In this catching cam a pre-alignment of the cam follower 34 is carried out. This catching cam 35a is followed by a process curve or a holding curve section 35b, within which the plastic preforms are preferably heated in the given position.

The process curve or the holding curve section 35b is followed by a transfer curve 35g, which aligns the rotational position of the plastic preforms in a desired shape in order to transfer the plastic preforms to a further transport device 14. In a preferred embodiment, the positions of the process curve and/or the transfer curve can be changed in order to adapt the rotational position to different process conditions.

In a further preferred embodiment, the apparatus has a drive device to adjust the process curve and/or the transfer curve. For example, an electromotive drive device can be provided which causes an adjustment of the process curve and/or the transfer curve.

FIG. 6 illustrates the transfer curve by means of which a spindle rotation is initiated in a clockwise direction (top view). As a result, the oven-outer side of the plastic preform in the blow mould will be oriented against the direction of rotation of the blow wheel.

FIG. 7 shows a further illustration of the holding device. Here again, the guide roller 34 is shown on the rotatable plate 32. The reference sign 26A indicates a mandrel which engages in the mouths of the plastic preforms in order to hold them in place. This mandrel 26a can also have clamping mechanisms which serve to clamp the plastic preform.

FIG. 8 shows a top view of the holding device shown in FIG. 7. Here again, the guide roller 34 is arranged on an arm 35, which in turn is attached to the plate 32. The guide curves allow a 90° correction of the rotational position of the spindle drive or the guide roller.

Due to the preferably adjustable or shiftable process curve or the holding curve section 35b (cf. FIG. 5), all concepts described below can also be used to control or adjust the average transfer angle. For this purpose, the drive of the process curve is preferably readjusted depending on a measured transfer angle.

In this way, for example, process control of preferential heating machines can be carried out (for example, to counteract a drift of the transfer angle during the warm-up of the oven).

However, new customer objects can also be used on corresponding machines that allow preferential heating.

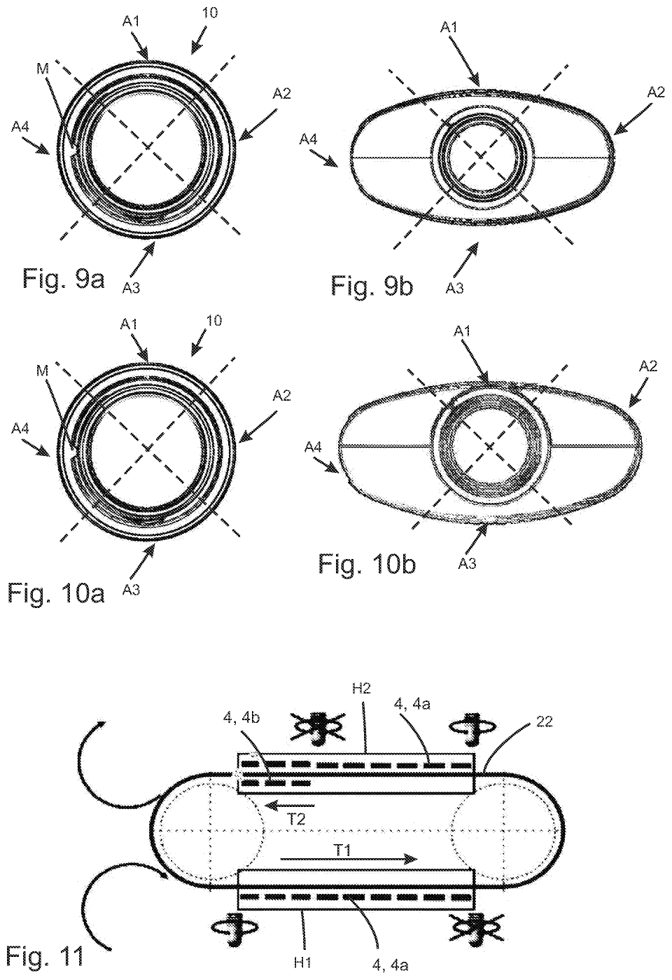

FIG. 9a, b show an illustration of the production of a plastic container. This container can also be produced using the apparatus shown in FIGS. 1-8. FIG. 9a shows a top view of a plastic preform 10 to be heated, which has four sections A1, A2, A3 and A4 on its outer surface. Sections A1 and A3 are heated more than sections A2 and A4. The more heated sections A1 and A3 result in the longer container sides A1 and A3 during forming and the less heated sections result in the shorter container sides A2 and A4 (cf. FIG. 9b). The reference sign M indicates a marking arranged on the plastic preform, which can be used to align the rotational position.

FIG. 10a,b show an illustration for the production of a plastic container. The production of this plastic container is also possible with the apparatus shown in FIGS. 1-8. Here, sections A1 and A3 are also heated differently (sections A2 and A4, however, are heated in the same way and to a lesser extent). More precisely, section A3 is heated even more than section A1. Accordingly, there is also a section A1 that is more stretched (compared to sections A2 and A4) and a section A3 that is even more stretched compared to this section A1 and thus in overall an asymmetrically shaped plastic container.

FIG. 11 shows a schematic representation of an apparatus for producing such oval cross-sections. The individual features of this apparatus were described in detail in FIGS. 1-8, so reference is made to them here.

In this process, plastic preforms are first guided through a first heating lane H1 or along the first transport path section T1 in which they are irradiated on one side by heating units and at the same time rotated in order to achieve the required basic thermal level for stretching in the subsequent blow moulding process. After this has been achieved, the rotation is stopped and the plastic preforms are guided through a heating lane H2, more precisely, the left part of the heating lane 2 with irradiation on both sides, i.e. along the transport path section T2. If it is necessary that the sides of the plastic preforms heated during this process do not have the same temperature, this can be very easily implemented in terms of control via the radiator output.

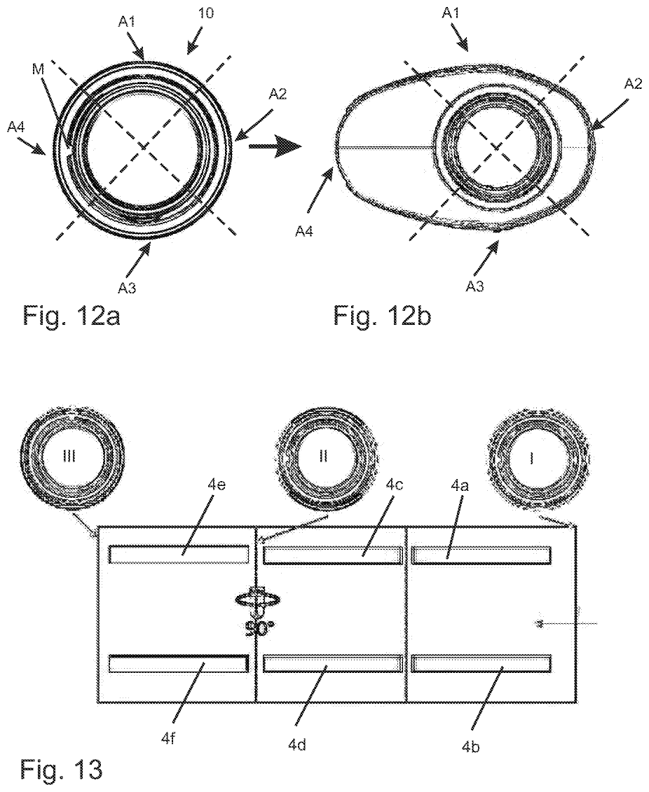

FIG. 12a, 12b illustrate the production of oval and asymmetrical plastic containers.

For the production of unevenly shaped, in particular oval, containers with asymmetrical short container side, two opposite sections A1 and A3 with highest temperature and two opposite preform sides with medium (section A4) and lowest temperature (section A2) are required. This heat distribution cannot be achieved by adjusting the radiator power alone.

Preferably, there are transition areas between the circumferential sections, or between said sections and the sections adjacent to these sections (A1 to A2, A2 to A3, etc.). These transition areas result, among other things, from the not only orthogonally incident IR radiation, but also from thermal conduction and other relationships.

FIG. 13 illustrates the method proposed within the scope of the invention for the production of such containers. In order to achieve the required heat distribution for the production of oval containers which are at the same time asymmetrical on the short side of the container, a swivel in the preferential heating module, i.e. the heating device 2, is proposed.

First, the plastic preforms, which have already been uniformly preheated, are fed in on the right side (I). Then the rotary position is held and these plastic preforms are transported (II) past the heating units 4a-4d and heated from both sides. There is significantly more heating at the sections A1 and A3 shown above.

If desired, the heating units 4a,c can also emit a different radiant power than the heating units 4b,d. In this way, asymmetrical heating of sections A1 and A3 can be achieved.

In a further step, the plastic preforms are rotated by 90° (III) and now the heating units 4e, 4f heat the sections A2 and A4 shown above more strongly.

At the outlet of the heating device, plastic preforms therefore result with two strongly heated sections (A1, A3), one moderately heated section (A2) and one weakly heated section (A4).

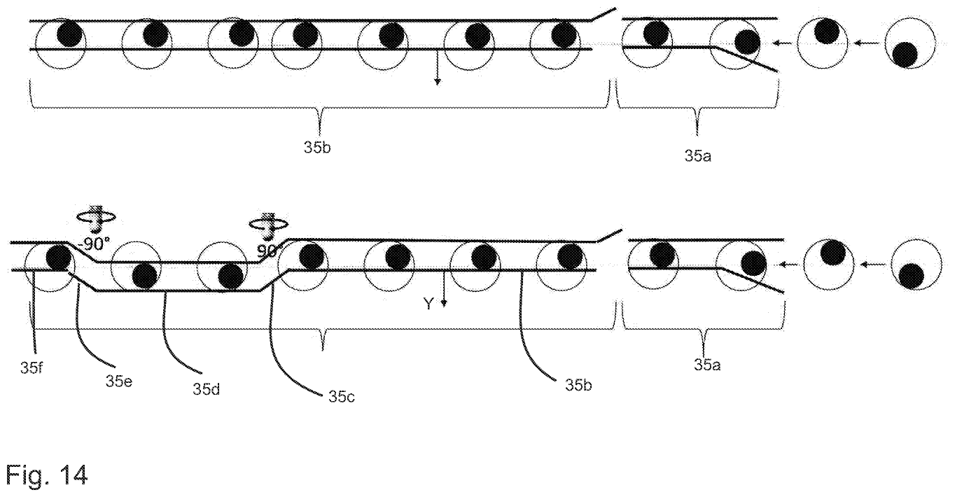

FIG. 14 shows an illustration of an actuator for implementing the method described in FIG. 13.

As already described above, a guide roller at the upper end of the spindles is used to guide the preforms in the heating device 2. Due to the guide rollers on the spindles, which are already in use, the 90° swivel can be carried out very easily via the guide curve above the heating device. For this purpose, the previous nominal position of 45° with respect to the spindle centre point can be changed from outside to 45° inside. In order to maintain the previous overall concept, it is advisable to return to the previous target position at the end of the Preferential Heating process by a −90°-swivel.

The upper partial illustration in FIG. 14 shows the procedure according to the applicant's internal prior art.

The bottom illustration shows a method according to the invention. The plastic preforms coming from the right can still have any orientation. A catch cam section aligns the guide roller in such a way that it lags outwards by 45° relative to the spindle centre.

A first holding cam section 35b holds the holding devices or spindles in this position and thus guides the plastic preforms past the heating units 4a-4d shown in FIG. 13. However, the guide curve section 35b is preferably adjustable along the arrow Y, so that this setting angle can also be changed.

In a transition section 35c, the rotational position of the plastic preforms is rotated by 90°, which is done by moving the guide roller to a position in which it lags inwards by 45° relative to the spindle centre.

In this rotational position, the plastic preforms are now heated by the heating units 4e, 4f shown in FIG. 13, which takes place during transport with the holding curve section 35d. In a further optional transition section, the plastic preforms are rotated by −90° to return to the initial position after the catch curve section 35a.

The applicant reserves the right to claim all features disclosed in the application documents as essential to the invention, provided they are individually or in combination new compared to the prior art. It is further pointed out that the individual figures also describe features which may be advantageous in themselves. The skilled person immediately recognises that a certain feature described in a figure can also be advantageous without adopting further features from this figure. Furthermore, the skilled person recognises that advantages can also result from a combination of several features shown in individual figures or in different figures.

1. A method for producing plastic containers, wherein plastic preforms are heated by a heating device and subsequently these heated plastic preforms are formed into the plastic containers, wherein the plastic preforms are transported during their heating along a predetermined transport path and wherein the plastic preforms are rotated with respect to their longitudinal axis during transport along a first transport path section in order to achieve uniform heating of the plastic preforms in the circumferential direction and wherein the plastic preforms remain at least in sections in a predetermined first rotational position with respect to their longitudinal axis during their transport along a second transport path section so that first predetermined circumferential sections of the plastic preforms are heated differently from second predetermined circumferential portions of the plastic preforms,
wherein
the plastic preforms remain at least in sections in a predetermined second rotational position with respect to their longitudinal axis during their transport along the second transport path section, wherein the first and the second rotational position differing from one another by a predetermined differential angle.

2. The method according to claim 1,
wherein
the differential angle is greater than 20° and/or that the differential angle is less than 160°.

3. The method according to claim 1,
wherein
the plastic preforms are rotated from the first rotational position into the second rotational position by a mechanical setting device.

4. The method according to claim 1,
wherein
during a transport of the plastic preforms in the second transport path section, mutually opposite circumferential sections are heated differently at least in sections.

5. The method according to claim 1,
wherein
the forming device forms plastic containers from the plastic preforms with a cross-section deviating from a circular cross-section.

6. The method according to claim 1,
wherein
the plastic preforms are cooled at least in sections during their transport along the transport path on their outer surface.

7. The method according to claim 1,
wherein
a detection device detects a rotational position of the plastic preforms with respect to their longitudinal direction.

8. An apparatus for producing plastic containers, having a heating device which heats plastic preforms, wherein the heating device has a transport device which transports the plastic preforms along a predetermined transport path during their heating, wherein the heating device has at least one heating unit, which is configured to heat the plastic preforms by applying electromagnetic radiation, and wherein the heating device having a rotating device which is configured to rotate the plastic preforms with respect to their longitudinal axis during transport along a first transport path section in order to achieve uniform heating of the plastic preforms in the circumferential direction, and wherein the heating device has a setting device which is configured to cause the plastic preforms to be transported during their transport along a second transport path section at least in sections in a predetermined first rotational position with respect to their longitudinal axis, so that first predetermined circumferential sections of the plastic preforms are heated differently from second predetermined circumferential sections of the plastic preforms,
wherein
the setting device is configured to cause the plastic preforms to be transported during their transport along the second transport path section at least in sections in a predetermined second rotational position with respect to their longitudinal axis, wherein the first and the second rotational position differ from one another by a predetermined differential angle.

9. The apparatus according to claim 8,
wherein
the setting device has at least one guide cam which is arranged in a stationary manner, which enables the plastic preforms to be transported in a predetermined rotational position.

10. The apparatus according to claim 9,
wherein
the guide cam comprises at least three successive curve sections, wherein one of these curve sections is a catching curve section which is configured to align the plastic preforms with respect to the rotational position relative to the longitudinal axis of the plastic preforms, at least one curve section is a first holding curve section which is configured to hold the plastic preforms in the first rotational position during their transport, and at least one curve section is a second holding curve section which is configured to hold the plastic preforms in the second rotational position during their transport.

11. The apparatus according to claim 10,
wherein
the guide cam has a transfer section which rotates the plastic preforms from the first rotational position into the second rotational position and the guide cam has a further transfer section which is configured to rotate the plastic preforms from the second rotational position into a further rotational position.

12. The apparatus according to claim 8,
wherein
heating units are arranged at least in sections in the second transport path section on both sides of the transport path of the plastic preforms, wherein these heating units are preferably controllable independently of one another.

13. The apparatus according to claim 8,
wherein
the apparatus comprises at least one inspection device which is configured for detecting a rotational position of the plastic preforms with respect to their longitudinal direction.

14. The apparatus according to claim 8,
wherein
the apparatus comprises a forming device which is configured to form the plastic preforms heated by the heating device into plastic containers, wherein said forming device is configured for producing plastic containers with a cross-section deviating from a circular cross-section.
